(19) United States
(12) Patent Application Publication
(10) Pub. No.: US 2026/0210302 A1
(43) Pub. Date: Jul. 23, 2026

(54) Integrated Engine Management Device and System

(71) Applicant: MARELLI SISTEMAS AUTOMOTIVOS INDUSTRIA E COMERCIO BRASIL LTDA, Hortolandia (BR)

(72) Inventors: Alex Pereira Lopes, Hortolandia (BR); Diogo Pereira Bessa, Campinas (BR); Fernando Luiz Windlin, Jundiai (BR); Léo Vitor Peron, Hortolandia (BR); Alexandre Alves Sampaio E Silva, Amparo (BR); Flavio Martins Ramires, Indaiatuba (BR); Vagner Eduardo Gavioli, Americana (BR); Francisco Sales Ávila Cavalcante, Fortaleza (BR); Ana Luiza Bessa De Paula Barros, Fortaleza (BR); Francisco Frederico Dos Santos Matos, Fortaleza (BR); Samuel Vieira Dias, Fortaleza (BR)

(21) Appl. No.: 19/452,616

(22) Filed: Jan. 19, 2026

(30) Foreign Application Priority Data
Jan. 20, 2025 (BR) 10202500061-5

(51) Int. Cl. F02D 9/10; F02D 41/18

(52) U.S. Cl. CPC F02D 9/1065; F02D 9/105; F02D 41/18

(57) ABSTRACT

An integrated engine management device physically and functionally incorporates an ECU and an ETB, for the unified management of small internal combustion engines (ICE) in equipment. The base of the integrated device is coupled to a cover, the base comprising a shaped seat for an engine and a valve body fitted with a throttle body, and the cover comprising a PCB and a male connector.

### CROSS-REFERENCE TO RELATED APPLICATION

This application claims priority to Brazilian Patent Application No. 10202500061-5 filed Jan. 20, 2025, the disclosure of which is hereby incorporated by reference in its entirety.

### BACKGROUND OF THE INVENTION

### Field of the Invention

The present invention relates to an integrated engine management device and an integrated engine management system. More specifically, the invention relates to an integrated device comprising and joining an ECU (Engine Control Unit) and an ETB (Engine Throttle Body), for the unified management of small internal combustion engines (ICEs).

### Description of Related Art

The stringency of emission standards has been increasing over the years, and with that, the use of internal combustion engines (ICEs) has to adapt to the new requirements. Global emission control programs (EURO in particular, which is in its sixth phase and preparing for its seventh stage) make the standards even more stringent with regard to emissions from mobile sources, whatever the application.

Yhe ICEs operating with gasoline, ethanol, mixtures or any other fuel, regardless of the thermal cycle, emit pollutants. Among the most common gases are carbon monoxide, hydrocarbons, sulfur dioxide, aldehydes, carbon dioxide, nitrogen oxides, particulate matter and vapors of these fuels. It is worth mentioning the EURO 6 standard, which differed from its previous phase by requiring a 72% reduction in the limit of hydrocarbon emissions, and an 80% reduction in nitrogen oxide emissions. EURO 7 discusses reducing the NOx emission limit, which in EURO 6 is approximately 80 mg (milligrams), to 60 mg (milligrams), which will require engines to adapt to this new demand regardless of whether they are applied to cars, trucks or small engines.

The ozone, which in the upper atmosphere protects the planet from ultraviolet rays, becomes extremely harmful when near the ground (tropospheric ozone), forming a harmful atmosphere that compromises human health and agriculture.

The increase in tropospheric ozone comes, among other sources, from gases emitted by motor vehicles and is significantly increased by the evaporation of fuels used.

These evaporative emissions occur with the increase in daytime temperature and consequent increase in fuel temperature in the tank and also at the time of refueling. At refueling, for example, 50 liters of gasoline have 75 g of vapor evaporated, or 100 mL of liquid gasoline.

In order to meet the legal limitations for pollutant emissions into the atmosphere, ICEs have been implementing new devices and methods in order to constantly reduce these emissions. For example, current vehicles have devices for capturing and recirculating fuel vapors, while combustion management is increasingly improved and controlled from lambda probes located at the exhaust manifold outlet and downstream of the catalytic converter.

Other components directly linked to the control and management of combustion and, therefore, directly linked to pollutant and particulate emissions, are the ECU and the ETB. The ETB (Engine Throttle Body) and the ECU (Engine Control Unit) are integral parts of the electronic fuel injection system of ICEs, whose functions are to meter the amount of air demanded by the ICE (via ETB) and manage the electrical and electronic functions of the ICE, a function of the ECU, thus contributing to the reduction of fuel consumption, as well as the reduction of vehicle emissions of gases harmful to health.

While in medium and large ICEs it is possible and relatively easy to incorporate new devices for controlling and reducing emissions, the same is not true for small engines. In particular, these ICEs must prioritize simplicity and ensure easy operation because they are not used frequently in the user's daily life, but when required they must provide the expected response for their intended purpose. In addition, these small engines must be simple, occupying the smallest possible size and having the lowest possible weight. Compactness is a fundamental factor.

Small engines are understood to be any thermal machine applied to equipment intended to assist in human work activities. Examples of such equipment include: lawnmowers, electricity generators, snowplows, augers (machines for drilling soil and ice), recreational vehicles, go-karts, motorcycles, jet skis, construction equipment, among others, and whose cylinder capacity does not exceed 1000 cm³, usually comprising 1 cylinder, and eventually 2 cylinders.

Another characteristic to be highlighted in small engines is the high level of vibration and temperature. Thus, any and all components intended for these applications must be designed to withstand these demands.

In this way, the need remains in the art for compact and highly functional devices, capable of being incorporated into equipment equipped with small engines, and aiming to fundamentally contribute to the reduction of emissions of gases harmful to health.

A specific objective of the invention comprises a compact device capable of integrating the functions of an ECU and an ETB. Another specific objective of the invention is a compact device in dimensions and mass, easy to install and presenting a reduced volume.

### SUMMARY OF THE INVENTION

These and other objectives are satisfied by an integrated engine management device, in particular for the management of an internal combustion engine (ICE) of a piece of equipment, the integrated device comprising an ETB throttle body and an engine control unit (ECU).

In particular, the device comprises a base coupled to a cover, the base comprising a shaped seat, preferably cylindrical, for a motor and a valve body fitted with a throttle body, and the cover comprising a PCB and a male connector.

The base of the integrated device houses a motor, at least one reduction gear and an actuator comprising a support shaft and rotational drive of the throttle body.

The motor comprises a drive shaft fitted with a transmission gear, said gear being rotationally coupled with an upper toothed disc of the reduction gear, and the lower toothed disc of the reduction gear being rotationally coupled with a toothed sector of the throttle actuator.

The actuator comprises a base disc on whose edge is formed the toothed sector or gear sector with an angular amplitude of 90° or other, and wherein the butterfly axis projects downwards from the base disc.

The base disc further comprises a cylindrical projection, coaxial with respect to the butterfly axis, the cylindrical projection defining a seat for a magnetic element.

The cover supports the PCB, the PCB comprising at least one processor, at least one memory, and wherein on the underside of the PCB is connected a magnetic position sensor, facing the magnetic element of the base disc and capable of identifying the angular position of the butterfly and transmitting such angular position signal to the processor.

The valve body comprises an intake duct inside which the butterfly rotates with an angular amplitude of 0 to 90° or other amplitude determined by the ICE.

Finally, the device is supported and held in position between an intake manifold and an intake nozzle of the ICE.

In addition, the objectives are met by an integrated engine management system, in particular for the management of an internal combustion engine (ICE) of a unit, comprising an ETB throttle body and an ECU engine control unit integrated into an integrated device, the integrated device being able to meter the amount of air demanded by the ICE and manage the electrical and electronic functions of the ICE. Furthermore, the integrated device is able to directly meter the amount of air demanded by the ICE and externally manage the electrical and electronic functions of the ICE.

### BRIEF DESCRIPTION OF THE DRAWINGS

The terms Fig., Figs., Figure, and Figures are used interchangeably in the specification to refer to the corresponding figures in the drawings.

The object of the present invention may be better understood from the detailed description that follows, in a preferred and non-limiting embodiment of the invention, which is made with the support of the attached figures, presented by way of illustration and not limitation, in which:

FIG. 1 is a top perspective view of an integrated device comprising an ECU and an ETB, according to the present invention;

FIG. 2 is a bottom perspective view of the device of the invention;

FIG. 3 is a top perspective view of the assembly of the electromechanical components;

FIG. 4 is a bottom perspective view of the assembly of the electromechanical components;

FIG. 5 is a side elevation view of the assembly of the electromechanical components;

FIG. 6 is a perspective view of the components of the throttle valve actuation mechanisms;

FIG. 7 is a perspective view of the throttle valve position monitoring system; and

FIGS. 8 and 9 are perspective views of the integrated device of the invention, coupled downstream of the air intake nozzle and upstream of the air/fuel mixture intake manifold for an ICE.

### DESCRIPTION OF THE INVENTION

In accordance with the attached figures, 1 is shown in its entirety as an integrated engine management device according to the invention. More particularly, the integrated device 1 incorporates the functions of an ECU and an ETB in a single physical component, resulting in the sharing of components and sensors, the elimination of cables and electrical connection harnesses, and a volumetric reduction of the ICE (not shown) of the equipment.

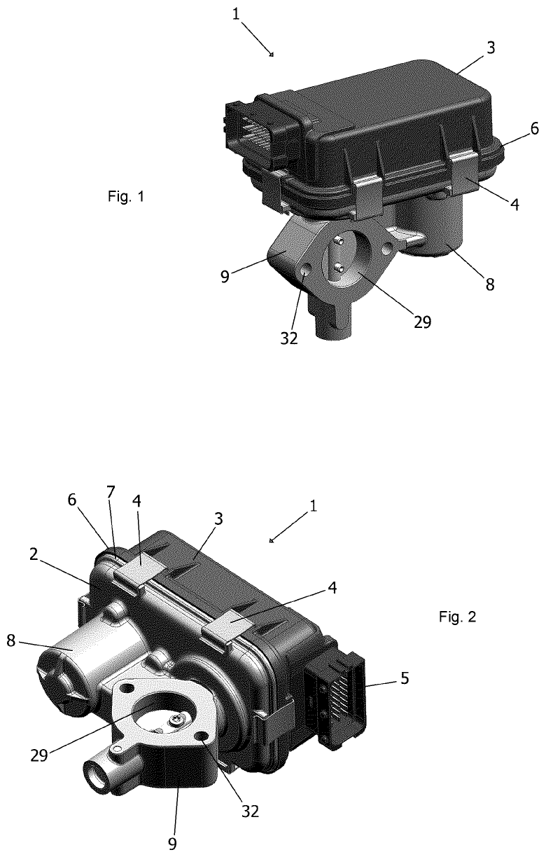

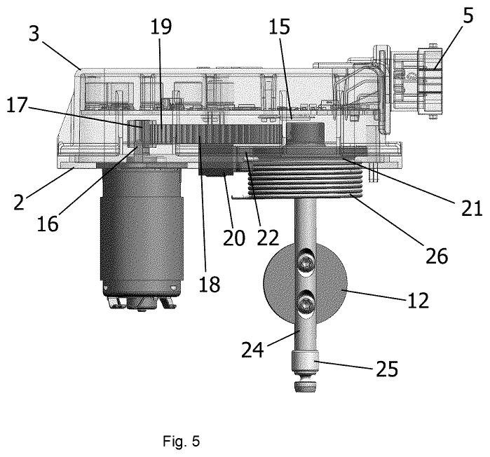

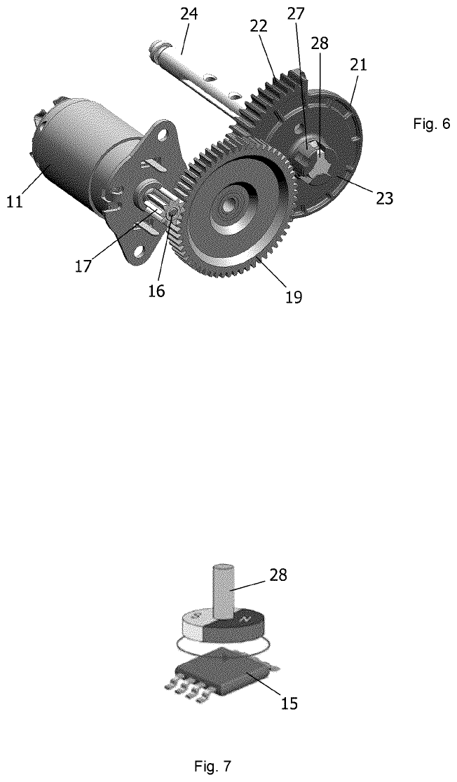

In more detail, the integrated device 1 comprises a base 2, preferably obtained by die-casting in aluminum, shaped, on which a cover 3 is disposed, thus defining an isolated and sealed internal volume. The cover 3 is fixed to the base 2 by means of locking springs 4, which engage with the lower edge 6 of the cover 3 and engage with respective reliefs of the base 2, thus fixing (in a watertight manner) and maintaining the position of the cover 3 in relation to the base 2. In one embodiment, a sealing element or gasket (not shown) is provided between the base 2 and the cover 3. Positioning reference as per FIG. 1 or 5.

In particular, the cover 3 has a parallelepiped shape, from which a male connector 5 projects, capable of receiving a respective terminal (not shown) from an ICE harness. The said harness, in addition to providing the electrical power to the integrated device 1, is also capable of sending and receiving command signals, sensor signals, among others.

Furthermore, base 2 is defined by a basically flat upper portion and enclosed by an upper edge 7, dimensionally corresponding to the lower edge 6 of the cover 3. From said upper portion of base 2, extending downwards, a shaped seat 8, preferably cylindrical, and a valve body 9 are defined, suitable for receiving, respectively, a DC motor 11 and a throttle body 12, as will be described in more detail below.

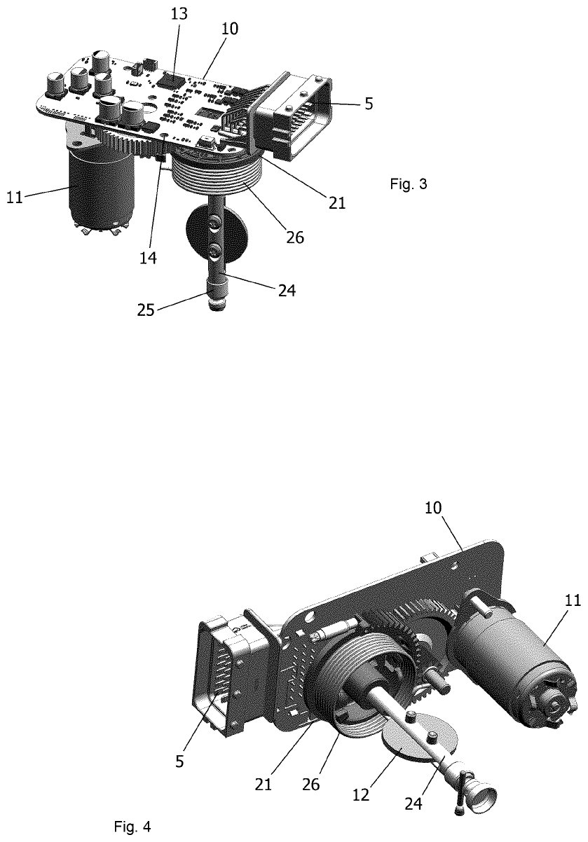

FIGS. 3 to 5 illustrate, more clearly, the internal components of the integrated device 1, as well as the respective relative positions of the preferred embodiment. In short, the internal volume of the integrated device 1 is divided, in height, by the PCB 10, the upper portion of this volume being reserved for electronic components while the lower portion is preferably reserved for mechanical components, but not exclusively, since the PCB 10 is a double-sided circuit board. Alternatively, PCB 10 is a multilayer circuit board.

The top face of PCB 10 is preferably intended to receive the electronic components, among which are at least one processor 13, at least one memory 14, as well as the terminals of the male connector 5, which are directly soldered onto PCB 10. In addition a magnetic position sensor 15 is connected to the bottom face of PCB 10, the operation of which will be explained later.

In one embodiment, and in view of fixing the terminals of the male connector directly onto PCB 10, PCB 10 is fixed to the cover 3, for example, by means of pillars (not illustrated) that project downwards, via fitting, by means of screws or other appropriate forms of fastening.

For the purposes of this description, processor 13 may be a general-purpose processor, a special-purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGA) circuits, any other type of integrated circuit (IC), and the like. In addition, and for the purposes of this description, memory 14, or generically a data storage medium, may be a read-only memory (ROM), a random access memory (RAM), a solid-state memory, a register, a cache memory, or other semiconductor memory devices.

In particular, processor 13 receives the power or torque demand from the equipment user and, based on signals received from the various sensors of the equipment to which the integrated device 1 is coupled, acts in controlling fuel injection and, directly, in controlling the fresh air intake through the position of the throttle valve 12 of the integrated device 1. In particular, and if the ICE of the equipment is an Otto cycle engine, the integrated device 1 acts mainly in controlling the flow of admitted air.

Regarding the control of the flow of fresh air admitted into the ICE, the lower portion of the internal volume of the integrated device 1 is intended to receive the throttle valve and the respective means of actuation and control thereof.

For this purpose, the base 2 comprises a shaped seat 8 inside which the DC motor 11 is disposed. The drive shaft 16 of the motor 11 projects into the lower portion of the internal volume of the integrated device 1, receiving a toothed transmission gear 17. In turn, the transmission gear 17 is rotationally coupled with a double reduction gear 18, that is, composed of an upper toothed disc 19 and a lower toothed disc 20, wherein the number of teeth of the upper toothed disc is greater than the number of teeth of the lower toothed disc. Furthermore, the lower toothed disc 20 is rotationally coupled with the toothed sector 22, or gear sector of the butterfly 12 actuator 21.

With particular attention to the butterfly 12 actuator 21, this comprises a base disc 23 from the edge of which the toothed sector 22 is formed. Said toothed sector 22 has an angular amplitude of the order of 90°, sufficient to allow the butterfly 12 to be angularly displaced from a position of maximum opening to a position of closing of the butterfly valve, or more specifically, of the intake duct 29 of the valve body 9 inside which the butterfly 12 rotates. For this purpose, shaft 24 supports and promotes the rotational actuation of the butterfly valve 12, being fixed at the top to the base disc 23, while the opposite, lower end of shaft 24 receives a sliding bushing 25 capable of allowing the rotation of shaft 24 in relation to base 2, on which the actuator 21 is supported.

In addition, the actuator 21 also comprises a helical spring 26, whose ends are linked to base 2 and base disc 23 so that, in the event of mechanical failure, the butterfly valve 12 is automatically moved to the butterfly valve closing position.

Finally, the base disc 23 also comprises a cylindrical projection 27, coaxial with respect to the axis 24 of the throttle 12, which defines a seat for a magnetic element 28. As particularly illustrated in FIGS. 5 and 7, the aforementioned magnetic position sensor 15 fixed to the lower face of the PCB 10 is positioned close to the magnetic element 28, so as to identify the angular position of the throttle 12 and transmit such angular position signal to the processor 13 through at least one trace of the PCB 10. In this way, the signal sent by the magnetic position sensor 15 to the processor 13 indicates the angular position of the throttle 12 internally located in the intake duct 29, and the angular position of the throttle 12 defines the flow of fresh air, or atmospheric air, that enters the combustion chamber of the ICE.

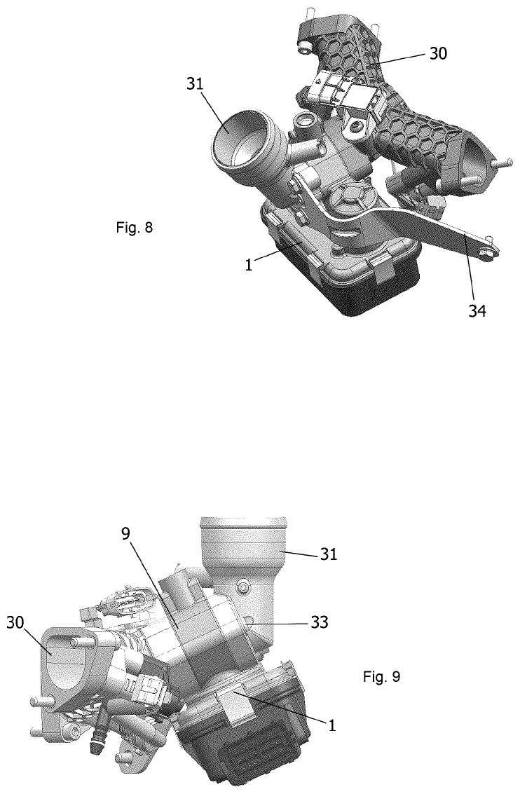

FIGS. 8 and 9 represent two perspective views of a possible mounting of the integrated device 1 in relation to the air intake nozzle 31 and the air/fuel mixture intake manifold 30 of the ICE. For this purpose, the valve body 9 comprises a pair of through holes 32 (see specifically FIGS. 1 and 2) through which respective screws 33 (FIG. 9) securely fix the intake nozzle 31 and the intake manifold 30 on opposite sides of the valve body 9.

Furthermore, a support blade 34 is attached to the intake nozzle 31, which can be fixed, at its opposite end, to a housing or chassis of the equipment. Similarly, the intake manifold 30 is fixed, at least at one end, to the ICE block. In this way, the integrated device 1 is held fixed to the equipment indirectly, that is, through the intake nozzle 31 and the intake manifold 30. In any case, its disassembly, if necessary, is simple and quick since it is obtained by removing the two screws 33.

Just to note, since it is known to technicians in the sector, upstream of the intake nozzle 31 it is possible to provide an air filter (not shown), in order to filter fresh air, or atmospheric air, before mixing with the fuel and before this mixture is admitted into the combustion chamber of the ICE. On the other hand, the intake manifold 30 may provide one or more fuel injectors, whose injection times are controlled by the integrated device 1, the intake manifold 30 receiving a flow of fresh air and a flow of injected fuel, both proportionally metered by the integrated device 1, the mixture of flows being sent to one or more cylinder(s) of the ICE. Alternatively, the fresh air flow is directed directly to the cylinder(s) through the intake manifold duct(s), while the fuel flow is injected by the fuel injector.

Furthermore, all internal elements (metallic, plastic and elastomeric) through which intake air and fuel vapors, gasoline, ethanol and mixtures thereof circulate are designed and tested to withstand the entire life of the equipment or device (full life) without compromising its operation. Furthermore, all mechanical and electro-electronic components are specified and designed to withstand the vibrations and temperatures imposed by the ICE.

In operation, once the equipment is switched on, at least through the ICE start-up, the user transmits a power demand to the integrated device 1 through electrical signals transferred from a control via the electrical connection harness and male connector 5. Thus, the integrated device 1 calculates the necessary flows of fresh air and fuel for the requested power and torque demand, changing the position of the throttle 12 and controlling the fuel injection times via electrical signals through the aforementioned male connector 5 and electrical connection harness. The actuation of throttle 12 is performed by the DC motor 11, while its angular position is controlled by the magnetic position sensor assembly 15 of PCB 10 and magnetic element 28, of the throttle shaft 24. In time, the integrated device 1 keeps the fuel injection times and the position of throttle 12 under control, always according to the power and torque demand and, if provided, a lambda probe (not shown) that informs the integrated device 1 about the composition of the exhaust gases in order to adjust the fuel injection times (or fuel mixture) to improve combustion and reduce emissions of pollutants and particulates.

As can be seen, the integrated device 1, according to the invention, has a very compact layout in size and mass and is particularly suitable for use in small equipment, equipped with equally small ICEs and small displacement, resulting from the functional integration operated by the integrated device 1.

1. An integrated engine management device, in particular for managing an internal combustion engine ICE of a piece of equipment, wherein the integrated device comprises an ETB throttle body and an ECU engine control unit.

2. The device of claim 1, wherein a base is coupled to a cover, the base comprising a cylindrical shaped seat for a motor and a valve body fitted with a throttle body, and the cover comprising a PCB and a male connector.

3. The device of claim 1, wherein the base of the integrated device houses a motor, at least an reduction gear and an butterfly actuator comprising a shaft for supporting and rotating the throttle body.

4. The device of claim 3, wherein the motor comprises a drive shaft fitted with a transmission gear, the transmission gear being rotatably coupled with an upper toothed disc of the reduction gear, and an lower toothed disc of the reduction gear being rotatably coupled with a toothed sector of the butterfly actuator.

5. The device of claim 3, wherein the butterfly actuator comprises a base disc on whose edge the toothed sector is formed with an angular amplitude of 90°, and an butterfly shaft projects downwards from the base disc.

6. The device of claim 5, wherein the base disc further comprises a cylindrical projection, coaxial with respect to the butterfly shaft of the butterfly valve, the cylindrical projection defining a seat for a magnetic element.

7. The device of claim 1, wherein the cover supports the PCB, the PCB comprising at least a processor, at least a memory and wherein on the underside of the PCB is connected a magnetic position sensor, facing the magnetic element of the base disc and the magnetic position sensor is capable of identifying the angular position of the butterfly valve and transmitting such angular position signal to the processor.

8. The device of claim 1, wherein the valve body comprises an intake duct inside which the butterfly valve rotates.

9. The device of claim 1, wherein the device is supported and held in position between an intake manifold and an intake nozzle of the ICE.

10. An integrated engine management system, in particular for the management of an internal combustion engine ICE of an equipment comprising an ETB throttle body and an ECU engine control unit integrated into an integrated device, wherein the integrated device is able to meter the amount of air demanded by the ICE and manage the electrical and electronic functions of the ICE.

11. The system of claim 10, wherein the integrated device is able to directly meter the amount of air demanded by the ICE and externally manage the electrical and electronic functions of the ICE.
